(19) United States
(12) Patent Application Publication
(10) Pub. No.: US 2023/0331578 A1
(43) Pub. Date: Oct. 19, 2023

(54) PREPARATION METHOD OF POROUS OXIDE

(71) Applicant: DALIAN INSTITUTE OF CHEMICAL PHYSICS, CHINESE ACADEMY OF SCIENCES, Dalian (CN)

(72) Inventors: Jiacheng XING, Dalian (CN); Danhua YUAN, Dalian (CN); Yunpeng XU, Dalian (CN); Zhongmin LIU, Dalian (CN)

(73) Assignee: DALIAN INSTITUTE OF CHEMICAL PHYSICS, CHINESE ACADEMY OF SCIENCES, Dalian (CN)

(21) Appl. No.: 18/026,828

(22) PCT Filed: Sep. 17, 2020
(86) PCT No.: PCT/CN2020/115808

§ 371 Date: Mar. 17, 2023

(51) Int. Cl. C01G 23/04; C01F 7/30

(52) U.S. Cl. CPC C01G 23/04; C01F 7/30; C01P 2006/16; C01P 2006/12

(57) ABSTRACT

A preparation method of a porous oxide is provided, which includes: preparing the porous oxide with a polyester polyol as a raw material. The porous oxide prepared by the preparation method in the present application has characteristics such as uniform and adjustable pore sizes and controllable distribution of mesopores, micropores, and macropores.

### CROSS REFERENCE TO THE RELATED APPLICATIONS

This application is the national phase entry of International Application No. PCT/CN2020/115808, filed on Sep. 17, 2020, the entire contents of which are incorporated herein by reference.

### TECHNICAL FIELD

The present application relates to a preparation method of a porous oxide and belongs to the field of material synthesis.

### BACKGROUND

Porous oxides have important applications in basic research and industrial production. A porous oxide is an oxide system composed of oxygen and other elements. Porous oxides can have important applications in catalysis, petroleum cracking, gas separation, drug carriers, and other fields. Since porous oxides are amorphous materials, the synthesis control of porous oxides is complicated. At present, there is a lack of effective means for synthesis control. The synthesis control mainly includes the control of pore size and mesopore and micropore distribution of a porous oxide. Traditionally, a porous oxide is synthesized mainly by a sol-gel method using a soft template, that is, a raw material is mixed with a surfactant, a resulting mixture is allowed to form a micelle in a solution system, and then the raw material is hydrolyzed and roasted to obtain the porous oxide. However, in this method, it is difficult to control the size of the micelle during synthesis and control the pore size and specific surface area (SSA) of the porous oxide during roasting, hydrolysis rates of some parts of the raw material do not match with each other, and the use of the surfactant leads to a high cost.

### SUMMARY

According to an aspect of the present application, a preparation method of a porous oxide is provided. The porous oxide prepared by the preparation method has characteristics such as uniform and adjustable pore sizes and controllable distribution of mesopores, micropores, and macropores.

The porous oxide of the present application is obtained by roasting a polyester polyol polymer, where the polyester polyol refers to a new polyester polyol polymer obtained by subjecting an oxygen-containing acid ester and a polyol to a transesterification reaction. The traditional polyester polyol is obtained by subjecting an organic acid and a polyol to a dehydration esterification reaction.

According a first aspect of the present application, a preparation method of a porous oxide is provided, including preparing the porous oxide with a polyester polyol as a raw material.

Optionally, the preparation method includes: in an atmosphere including a gas A, roasting a raw material including the polyester polyol to obtain the porous oxide, where the gas A is at least one selected from the group consisting of air, nitrogen, an inert gas, and oxygen.

Optionally, the atmosphere during the roasting is one or a mixture of two or more selected from the group consisting of air, oxygen, and nitrogen.

Optionally, the roasting is conducted at 350° C. to 900° C. for 1.5 h to 25 h.

Optionally, during the roasting, an upper limit of the temperature is independently selected from the group consisting of 900° C., 850° C., 800° C., 750° C., 700° C., 630° C., 600° C., 550° C., 500° C., 480° C., 475° C., 445° C., 420° C., 400° C., and 375° C.; and a lower limit of the temperature is independently selected from the group consisting of 350° C., 850° C., 800° C., 750° C., 700° C., 630° C., 600° C., 550° C., 500° C., 480° C., 475° C., 445° C., 420° C., 400° C., and 375° C.

Optionally, during the roasting, an upper limit of the roasting time is independently selected from the group consisting of 25 h, 20 h, 18 h, 15 h, 12 h, 9 h, 8 h, 7 h, 6 h, 4 h, 3 h, and 2 h; and a lower limit of the roasting time is independently selected from the group consisting of 1.5 h, 20 h, 18 h, 15 h, 12 h, 9 h, 8 h, 7 h, 6 h, 4 h, 3 h, and 2 h.

Optionally, the preparation method includes: subjecting a raw material including an oxygen-containing acid ester and a polyol to a transesterification reaction to obtain the polyester polyol.

Optionally, the oxygen-containing acid ester is at least one selected from the group consisting of a compound with a chemical formula shown in formula I and a compound with a chemical formula shown in formula II:

M(OR₁)ₙ¹ formula I

O═P(OR²)ₙ² formula II

where M is a metallic element or a non-metallic element excluding P; R¹ and R² each are independently at least one selected from the group consisting of C₁-C₈ alkyl groups; and n¹ is 2 to 8 and n² is 2 to 8.

Optionally, n¹ is 2, 3, 4, 5, 6, 7, or 8.

Optionally, n² is 3.

Optionally, M is at least one selected from the group consisting of B, Si, Ge, Al, Ti, Fe, Sn, V, Ga, Zr, Cr, Sb, and W.

Optionally, M is selected from the group consisting of B, Si, Ge, Al, Ti, Fe, Sn, V, Ga, Zr, Cr, Sb, and W.

Optionally, R¹ and R² in formula I each are independently at least one selected from the group consisting of C₁-C₄ alkyl groups.

Optionally, the oxygen-containing acid ester includes at least one selected from the group consisting of trimethyl borate, triethyl borate, tripropyl borate, tributyl borate, tri-n-hexyl borate, triisooctyl borate, trioctyl borate, tetramethyl orthosilicate (TMOS), tetraethyl orthosilicate (TEOS), tetrapropyl orthosilicate (TPOS), tetrabutyl orthosilicate (TBOS), ethyl orthogermanate, triethyl phosphate (TEP), tripropyl phosphate (TPP), tributyl phosphate (TBP), tri-n-pentyl phosphate, trihexyl phosphate (THP), aluminum triethoxide, aluminum isopropoxide, aluminum n-butoxide, aluminum tert-butoxide, tetraethyl titanate, tetraisopropyl titanate (TIPT), tetrabutyl titanate, tetrahexyl titanate, tetraisooctyl titanate, tetrabutyl ferrite, tetrabutyl stannate, butyl orthovanadate, gallium ethoxide, tetra-n-propyl zirconate, tetrabutyl zirconate, tert-butyl chromate, ethyl antimonite, butyl antimonite, tungsten ethoxide, and tungsten isopropoxide.

Optionally, a molar ratio of the oxygen-containing acid ester to the polyol meets the following condition:
oxygen-containing acid ester: polyol=(0.8−1.2) n³/x
where x represents a mole number of alkoxy in each mole of the oxygen-containing acid ester; and
n³ represents a mole number of hydroxyl in each mole of the polyol.

Optionally, an upper limit of the molar ratio of the oxygen-containing acid ester to the polyol is selected from the group consisting of 0.85 n³/x, 0.9 n³/x, 0.95 n³/x, 1 n³/x, 1.05 n³/x, 1.1 n³/x, 1.15 n³/x, and 1.2 n³/x; and a lower limit of the molar ratio of the oxygen-containing acid ester to the polyol is selected from the group consisting of 0.8 n³/x, 0.85 n³/x, 0.9 n³/x, 0.95 n³/x, 1 n³/x, 1.05 n³/x, 1.1 n³/x, and 1.15 n³/x, where x represents a mole number of alkoxy in each mole of the oxygen-containing acid ester; and n³ represents a mole number of hydroxyl in each mole of the polyol.

Optionally, there are no less than two hydroxyl groups in the polyol.

Optionally, the polyol includes at least one selected from the group consisting of ethylene glycol (EG), diethylene glycol (DEG), triethylene glycol (TEG), tetraethylene glycol, 1,2-propanediol, 1,3-propanediol, 1,4-butanediol, 1,6-hexanediol, polyethylene glycol (PEG) 200, PEG 400, PEG 600, PEG 800, 1,4-cyclohexanediol, 1,4-cyclohexanedimethanol (1,4-CHDM), 1,4-benzenedimethanol, glycerol, trimethylolpropane, pentaerythritol, xylitol, and sorbitol.

Optionally, the polyol has a general formula of R²—(OH)ₓ, where x≥2.

Optionally, the molar ratio of the oxygen-containing acid ester to the polyol is (0.8-1.2) n/x,
where x represents a mole number of alkoxy in each mole of the oxygen-containing acid ester; and n represents a mole number of hydroxyl in each mole of the polyol.

Optionally, the transesterification reaction is conducted in the presence of a transesterification catalyst.

Optionally, the transesterification catalyst is added at an amount of 0.1 wt % to 5 wt % of an amount of the oxygen-containing acid ester.

Optionally, an upper limit of the mass percentage of the amount of the transesterification catalyst in the amount of the oxygen-containing acid ester is selected from the group consisting of 0.2 wt %, 0.5 wt %, 0.8 wt %, 1.0 wt %, 1.5 wt %, 2.0 wt %, 2.5 wt %, 3.0 wt %, 3.5 wt %, 4.0 wt %, 4.5 wt %, and 5.0 wt %; and a lower limit of the mass percentage is selected from the group consisting of 0.1 wt %, 0.2 wt %, 0.5 wt %, 0.8 wt %, 1.0 wt %, 1.5 wt %, 2.0 wt %, 2.5 wt %, 3.0 wt %, 3.5 wt %, 4.0 wt %, and 4.5 wt %.

Optionally, the transesterification catalyst is at least one selected from the group consisting of an acidic catalyst and a basic catalyst.

Optionally, the acidic catalyst includes at least one selected from the group consisting of alcohol-soluble acids, solid acids, alkoxyaluminum, phenoxyaluminum, tetrabutyl stannate, alkoxytitanium, alkoxyzirconium, ethyl antimonite, and butyl antimonite; and
the basic catalyst includes at least one selected from the group consisting of alcohol-soluble bases and solid bases.

Optionally, the alcohol-soluble acids are acids that are soluble in alcohols.

Optionally, the alcohol-soluble bases are bases that are soluble in alcohols.

Optionally, the alcohol-soluble acids include sulfuric acid, sulfonic acid, or the like.

Optionally, the alcohol-soluble bases include NaOH, KOH, NaOCH₃, organic bases, or the like.

Optionally, the transesterification catalyst is a basic catalyst including alcohol-soluble bases (such as NaOH, KOH, NaOCH₃, and organic bases) and a variety of solid base catalysts; or an acidic catalyst including alcohol-soluble acids (such as sulfuric acid and sulfonic acid), a variety of solid acid catalysts, alkoxyaluminum, phenoxyaluminum, tetrabutyl stannate, alkoxytitanium, alkoxyzirconium, ethyl antimonite, and butyl antimonite. The transesterification catalyst is used at an amount of 0.1 wt % to 5 wt % of an amount of the oxygen-containing acid ester.

Optionally, the inert atmosphere is at least one selected from the group consisting of nitrogen and an inert gas.

Optionally, the inert atmosphere is nitrogen.

Optionally, the transesterification reaction is conducted under stirring.

Optionally, an upper limit of the temperature for the transesterification reaction is selected from the group consisting of 85° C., 90° C., 100° C., 110° C., 120° C., 130° C., 140° C., 150° C., 160° C., 170° C., 175° C., and 180° C.; and a lower limit of the temperature for the transesterification reaction is selected from the group consisting of 80° C., 85° C., 90° C., 100° C., 110° C., 120° C., 130° C., 140° C., 150° C., 160° C., 170° C., and 175° C.

Optionally, an upper limit of the reaction time for the transesterification reaction is selected from the group consisting of 3 h, 4 h, 5 h, 6 h, 7 h, 8 h, 9 h, and 10 h; and a lower limit of the reaction time for the transesterification reaction is selected from the group consisting of 2 h, 3 h, 4 h, 5 h, 6 h, 7 h, 8 h, and 9 h.

Optionally, a conversion rate of the transesterification reaction is 60% to 80%.

Optionally, after the transesterification reaction is completed, vacuum distillation is conducted.

Optionally, the vacuum distillation is conducted for 0.5 h to 5 h at a temperature of 170° C. to 230° C. and a vacuum degree of 0.01 KPa to 5 KPa.

Optionally, during the vacuum distillation, an upper limit of the vacuum degree is selected from the group consisting of 0.02 KPa, 0.05 KPa, 0.1 KPa, 0.5 KPa, 1 KPa, 2 KPa, 3 KPa, 4 KPa, 4.5 KPa, and 5 KPa; and a lower limit of the vacuum degree is selected from the group consisting of 0.01 KPa, 0.02 KPa, 0.05 KPa, 0.1 KPa, 0.5 KPa, 1 KPa, 2 KPa, 3 KPa, 4 KPa, and 4.5 KPa.

Optionally, during the vacuum distillation, an upper limit of the temperature is selected from the group consisting of 175° C., 180° C., 190° C., 200° C., 210° C., 220° C., 225° C., and 230° C.; and a lower limit of the temperature is selected from the group consisting of 170° C., 175° C., 180° C., 190° C., 200° C., 210° C., 220° C., and 225° C.

Optionally, during the vacuum distillation, an upper limit of the time is selected from the group consisting of 0.8 h, 1 h, 2 h, 3 h, 4 h, 4.5 h, and 5 h; and a lower limit of the time is selected from the group consisting of 0.5 h, 0.8 h, 1 h, 2 h, 3 h, 4 h, and 4.5 h.

Optionally, a conversion rate of the transesterification reaction is greater than 90%.

Optionally, the method includes:
a) mixing an oxygen-containing acid ester, a polyol, and a transesterification catalyst, and subjecting a resulting mixture to a transesterification reaction for 2 h to 10 h at 80° C. to 180° C. under stirring in an inert atmosphere; and
b) subjecting a reaction system obtained in step a) to vacuum distillation for 0.5 h to 5 h at a vacuum degree of 0.01 KPa to 5 KPa and a temperature of 170° C. to 230° C.

As a specific embodiment, the method includes:
1) thoroughly mixing an oxygen-containing acid ester, a polyol, and a transesterification catalyst in a three-necked flask, connecting the three-necked flask to a distillation device, introducing nitrogen for protection, and subjecting a resulting mixture to a transesterification reaction for 2 h to 10 h at 80° C. to 180° C. under stirring, where a conversion rate of the transesterification reaction is 60% to 80%; and
2) connecting the device obtained after the reaction in step 1) to a water pump or oil pump, and subjecting a resulting reaction system to vacuum distillation for 0.5 h to 5 h at a vacuum degree of 0.01 KPa to 5 KPa and a temperature of 170° C. to 230° C. to make the transesterification reaction more complete, where a conversion rate of the transesterification reaction is greater than 90%.

According to a second aspect of the present application, a porous oxide is provided, where the porous oxide is at least one selected from the group consisting of porous oxides prepared by the preparation method described above.

Optionally, the porous oxide has a pore size of 0.4 nm to 80 nm and an SSA of 150 m²/g to 1,500 m²/g.

Optionally, the porous oxide includes a micropore with a pore size of 0.4 nm to 2.0 nm.

Optionally, the porous oxide includes a mesopore with a pore size of 2.0 nm to 50 nm.

Optionally, the porous oxide includes a macropore with a pore size of 50 nm to 80 nm.

Optionally, the pore sizes and the mesopore and micropore distribution of the porous oxide are determined by physical adsorption methods, where the pore size of the micropore is analyzed by NLDFT and H-K methods, the pore size of the mesopore is analyzed by BJH and NLDFT methods, and the mesopore and micropore distribution is analyzed by a t-PLOT method.

In particular, the porous oxide prepared by the preparation method of the present application may include at least one selected from the group consisting of a micropore, a mesopore, and a macropore.

Optionally, the porous oxide prepared by the preparation method of the present application includes a micropore with a uniform pore size.

Optionally, the porous oxide prepared by the preparation method of the present application includes a mesopore with a uniform pore size.

Optionally, the porous oxide prepared by the preparation method of the present application includes a macropore with a uniform pore size.

Optionally, the porous oxide prepared by the preparation method of the present application includes a micropore with a uniform pore size and a mesopore with a uniform pore size.

In particular, a molecular size of the polyol in the present application can be controlled to obtain porous oxides with different pore sizes.

In particular, the controllable distribution of mesopores, micropores, and macropores in the present application means that the chain lengths of the polyol molecules in the present application can be controlled to obtain a porous oxide with different pore sizes.

Optionally, the porous oxide in the present application includes any one selected from the group consisting of a metallic oxide, a non-metallic oxide, and a metallic and non-metallic hybrid oxide.

In the present application, “C₁-C₈” refers to a number of carbon atoms in a group.

In the present application, the “alkyl group” is a group obtained by removing any hydrogen atom on an alkane molecule.

In the present application, the “initial decomposition temperature” refers to a temperature at which a significant weight loss peak of the polyester polyol occurs during thermogravimetric analysis (TGA).

Possible beneficial effects of the present application:
1) The porous oxide of the present application is synthesized through roasting with a polyester polyol as a raw material, which involves a simple process flow and overcomes the shortcomings such as poor repeatability, cumbersome operations, and difficult top-level design in the traditional method to synthesize a porous oxide. The synthesized porous oxide has uniform and adjustable pore sizes, controllable distribution of mesopores, micropores, and macropores, and very high designability.
2) The porous oxide prepared in the present application has the characteristics of adjustable pore sizes and controllable mesopore and micropore distribution, and can be widely used in adsorptive separation, catalytic oxidation, fine chemistry, and other fields.

### BRIEF DESCRIPTION OF THE DRAWINGS

FIG. 1 is a TGA diagram of the polyester polyol synthesized in Example 1 of the present application;

FIG. 2 is a Brunauer-Emmett-Teller (BET) diagram of the porous oxide synthesized in Example 1 of the present application;

FIG. 3 shows a pore distribution of the porous oxide synthesized in Example 1 of the present application;

FIG. 4 is a TGA diagram of the polyester polyol synthesized in Example 2 of the present application;

FIG. 5 is a BET diagram of the porous oxide synthesized in Example 2 of the present application;

FIG. 6 shows a pore distribution of the porous oxide synthesized in Example 2 of the present application;

FIG. 7 is a transmission electron microscopy (TEM) image of the porous oxide prepared in Example 1; and

FIG. 8 is a TEM image of the porous oxide prepared in Example 2.

### DETAILED DESCRIPTION OF THE EMBODIMENTS

The present application will be described in detail below with reference to examples, but the present application is not limited to these examples.

Unless otherwise specified, the raw materials in the examples of the present application are all purchased from commercial sources.

Analysis methods in the examples of the present application are as follows:

TGA is conducted using a TGA analyzer with a model of TAQ-600 produced by TA Instruments, where a flow rate of nitrogen is 100 mL/min, and a temperature is raised at a heating rate of 10° C./min to 700° C.

In an embodiment of the present application, the physical adsorption and pore distribution of a product are analyzed by the ASAP2020 automatic physical instrument of Micromeritics.

In an embodiment of the present application, a TEM image of a product is acquired by Thermo Fisher Themis™ ETEM.

In an embodiment of the present application, a conversion rate of the transesterification reaction is calculated in the following way:

According to a mole number n of alcohol distilled during the reaction, a number of groups participating in the transesterification reaction is determined to be n, and a total mole number of the ester in the reaction raw material is m, such that the conversion rate of the transesterification reaction is: n/xm, where x depends on a number of alkoxy groups in the esters that are attached to a central atom.

According to an embodiment of the present application, a preparation method of the porous oxide, a polyester polyol polymer, and a preparation method of the polyester polyol polymer are provided, and the preparation method of the porous oxide polymer includes the following steps:

a) An oxygen-containing acid ester, a polyol, and a transesterification catalyst are thoroughly mixed in a three-necked flask, the three-necked flask is connected to a distillation device, nitrogen is introduced for protection, and a resulting mixture is subjected to a transesterification reaction for 2 h to 10 h at 80° C. to 180° C. under stirring, where a conversion rate of the transesterification reaction is 60% to 80%.

b) The device obtained after the reaction in step a) is connected to a water pump or oil pump, and a resulting reaction system is subjected to vacuum distillation for 0.5 h to 5 h at a vacuum degree of 0.01 KPa to 5 KPa and a temperature of 170° C. to 230° C. to make the transesterification reaction more complete, where a conversion rate of the transesterification reaction is greater than 90%.

Optionally, the oxygen-containing acid ester in step a) has a general formula of M(OR)ₙ, where M is selected from the group consisting of B, Si, Ge, Al, Ti, Fe, Sn, V, Ga, Zr, Cr, Sb, and W and R is an alkyl group with 1 to 8 carbon atoms; and the oxygen-containing acid ester includes any one or a mixture of two or more selected from the group consisting of trimethyl borate, triethyl borate, tripropyl borate, tributyl borate, tri-n-hexyl borate, triisooctyl borate, trioctyl borate, TMOS, TEOS, TPOS, TBOS, ethyl orthogermanate, TEP, TPP, TBP, tri-n-pentyl phosphate, THP, aluminum triethoxide, aluminum isopropoxide, aluminum n-butoxide, aluminum tert-butoxide, tetraethyl titanate, TIPT, tetrabutyl titanate, tetrahexyl titanate, tetraisooctyl titanate, tetrabutyl ferrite, tetrabutyl stannate, butyl orthovanadate, gallium ethoxide, tetra-n-propyl zirconate, tetrabutyl zirconate, tert-butyl chromate, ethyl antimonite, butyl antimonite, tungsten ethoxide, and tungsten isopropoxide.

Optionally, the polyol in step a) has a general formula of R—(OH)ₓ, where x≥2; and the polyol includes any one or a mixture of two or more selected from the group consisting of EG, DEG, TEG, tetraethylene glycol, 1,2-propanediol, 1,3-propanediol, 1,4-butanediol, 1,6-hexanediol, PEG 200, PEG 400, PEG 600, PEG 800, 1,4-cyclohexanediol, 1,4-CHDM, 1,4-benzenedimethanol, glycerol, trimethylolpropane, pentaerythritol, xylitol, and sorbitol.

Optionally, a molar ratio of the oxygen-containing acid ester to the polyol in step a) is:

M(OR)ₙ/R—(OH)ₓ=(0.8−1.2)x/n.

Optionally, the transesterification catalyst used in step a) is a basic catalyst including alcohol-soluble bases (such as NaOH, KOH, NaOCH₃, and organic bases) and a variety of solid base catalysts; or an acidic catalyst including alcohol-soluble acids (such as sulfuric acid and sulfonic acid), a variety of solid acid catalysts, alkoxyaluminum, phenoxyaluminum, tetrabutyl stannate, alkoxytitanium, alkoxyzirconium, ethyl antimonite, and butyl antimonite. The transesterification catalyst is used at an amount of 0.1 wt % to 5 wt % of an amount of the oxygen-containing acid ester.

Optionally, the reaction in step a) is conducted for 2 h to 10 h at 80° C. to 180° C. under nitrogen protection.

Optionally, a conversion rate of the transesterification reaction in step a) is 60% to 80%.

Optionally, the step b) is conducted under vacuum distillation at a vacuum degree of 0.01 KPa to 5 KPa.

Optionally, the reaction in step b) is conducted at 170° C. to 230° C. for 0.5 h to 5 h.

Optionally, a conversion rate of the transesterification reaction in step b) is greater than 90%.

c) A product obtained after the reaction in step b) is roasted at 350° C. to 900° C. for 1.5 h to 20 h in an atmosphere that is one or a mixture of two or more selected from the group consisting of air, oxygen, and nitrogen.

### Example 1

10 g of 1,3-propanediol, 6.84 g of TEOS, and 5 g of TMOS were added to a three-necked flask, a distillation device was connected, and 0.12 g of concentrated sulfuric acid (mass fraction: 98%) was added dropwise as a catalyst under stirring; a temperature was raised to 100° C. under nitrogen protection to allow a reaction for 6 h, where a large amount of methanol and ethanol were distilled out and a conversion rate of the transesterification reaction was 75%; then a vacuum device was connected, and vacuum distillation was conducted to allow a reaction for 1 h at a vacuum degree of 1 KPa and a temperature of 170° C.; the reaction was stopped, a resulting reaction system was naturally cooled to room temperature, and a sample was taken out, where a conversion rate of the transesterification reaction was 93%; and the sample was roasted at 550° C. for 8 h in an air atmosphere to obtain a silicon porous oxide.

### Example 2

5 g of EG and 8.7 g of aluminum triethoxide were added to a three-necked flask, where the aluminum triethoxide served as both an oxygen-containing acid ester and a transesterification catalyst; a distillation device was connected, and a temperature was raised to 175° C. under nitrogen protection to allow a reaction for 5 h, where a large amount of ethanol was distilled out and a conversion rate of the transesterification reaction was 73%; then a vacuum device was connected, and vacuum distillation was conducted to allow a reaction for 1 h at a vacuum degree of 0.1 KPa and a temperature of 210° C.; the reaction was stopped, a resulting reaction system was naturally cooled to room temperature, and a sample was taken out, where a conversion rate of the transesterification reaction was 92%; and the sample was roasted at 750° C. for 4 h in an oxygen atmosphere to obtain an aluminum porous oxide.

### Example 3

10 g of 1,4-benzenedimethanol, 5.07 g of tripropyl borate, and 4 g of tetrapropyl titanate were added to a three-necked flask, where the tetrabutyl titanate served as both an oxygen-containing acid ester and a transesterification catalyst; a distillation device was connected, and a temperature was raised to 180° C. under stirring and nitrogen protection to allow a reaction for 6 h, where a large amount of propanol was distilled out and a conversion rate of the transesterification reaction was 75%; then a vacuum device was connected, and vacuum distillation was conducted to allow a reaction for 1 h at a vacuum degree of 1 KPa and a temperature of 230° C.; the reaction was stopped, a resulting reaction system was naturally cooled to room temperature, and a sample was taken out, where a conversion rate of the transesterification reaction was 93%; and the sample was roasted at 450° C. for 25 h in a mixed atmosphere of nitrogen and air to obtain a boron-titanium porous oxide.

### Example 4

Specific materials and reaction conditions involved were shown in Table 1 below, and other operations in a synthesis process were the same as in Example 1.

TABLE 1
Composition and ratio of raw materials and crystallization conditions in each of Examples 4 to 13

| | Transesterification | | | | | | | |
|---|---|---|---|---|---|---|---|---|
| | Oxygen- | | | | | Vacuum distillation | | |
| Example | containing | | | Reaction | Reaction | Vacuum | Reaction | Reaction |
| No. | acid ester | Polyol | Catalyst | temperature | time | degree | temperature | time |
| 4 | Tetrahexyl | DEG, 0.2 mol | NaOH, 0.03 g | 80° C. | 10 h | 5 KPa | 180° C. | 2 h |
| | titanate, 0.1 mol | | | | | | | |
| 5 | TEP, 0.2 mol | PEG 200, 0.3 mol | Na₂CO₃, 0.1 g | 100° C. | 5 h | 2 KPa | 200° C. | 0.5 h |
| 6 | Tetrabutyl | Trimethylolpropane, | Sulfonic | 150° C. | 2 h | 0.01 KPa | 175° C. | 5 h |
| | stannate, 0.15 mol | 0.2 mol | acid, 0.06 g | | | | | |
| 7 | Tungsten | Xylitol, 0.1 mol | Tetrabutyl | The same | The same | The same | The same | The same |
| | ethoxide, 0.2 mol | | stannate, 0.02 g | as in | as in | as in | as in | as in |
| | | | | Example 1 | Example 1 | Example 1 | Example 1 | Example 1 |
| 8 | Tetrabutyl | 1,4- | Ethyl | The same | The same | The same | The same | The same |
| | ferrite, 0.1 mol | Butanediol, 0.2 mol | antimonite, | as in | as in | as in | as in | as in |
| | | | 0.04 g | Example 1 | Example 1 | Example 1 | Example 1 | Example 1 |
| 9 | Butyl | Glycerol, 0.2 mol | Butyl | The same | The same | The same | The same | The same |
| | orthovanadate, | | antimonite, | as in | as in | as in | as in | as in |
| | 0.1 mol | | 0.02 g | Example 1 | Example 1 | Example 1 | Example 1 | Example 1 |
| 10 | Gallium | Pentaerythritol, | The same | The same | The same | The same | The same | The same |
| | ethoxide, | 0.3 mol | as in | as in | as in | as in | as in | as in |
| | 0.4 mol | | Example 1 | Example 1 | Example 1 | Example 1 | Example 1 | Example 1 |
| 11 | Tetra-n-propyl | Cyclohexanediol, | The same | The same | The same | The same | The same | The same |
| | zirconate, | 0.4 mol | as in | as in | as in | as in | as in | as in |
| | 0.2 mol | | Example 1 | Example 1 | Example 1 | Example 1 | Example 1 | Example 1 |
| 12 | Tert-butyl | The same | The same | The same | The same | The same | The same | The same |
| | chromate, 0.1 mol | as in | as in | as in | as in | as in | as in | as in |
| | | Example 1, | Example 1 | Example 1 | Example 1 | Example 1 | Example 1 | Example 1 |
| | | 0.1 mol | | | | | | |
| 13 | Ethyl | The same | The same | The same | The same | The same | The same | The same |
| | antimonite, | as in | as in | as in | as in | as in | as in | as in |
| | 0.4 mol | Example 1, | Example 1 | Example 1 | Example 1 | Example 1 | Example 1 | Example 1 |
| | | 0.3 mol | | | | | | |

TABLE 2
Roasting conditions in Examples 4 to 13

| | Roasting treatment | | | |
|---|---|---|---|---|
| Example | | | | Roasting |
| No. | Atmosphere | Roasting time | | temperature |
| 4 | Nitrogen | 1.5 | h | 380° C. |
| 5 | Oxygen | 2.5 | h | 400° C. |
| 6 | Air | 3 | h | 500° C. |
| 7 | Air and oxygen | 7.5 | h | 550° C. |
| 8 | Air and nitrogen | 8 | h | 600° C. |
| 9 | Nitrogen and oxygen | 10 | h | 650° C. |
| 10 | Air, nitrogen, | 9 | h | 750° C. |
| | and oxygen | | | |
| 11 | Nitrogen | 14 | h | 850° C. |
| 12 | Air | 16 | h | 900° C. |
| 13 | Oxygen | 20 | h | The same as in |
| | | | | Example 1 |

### Example 5 TGA

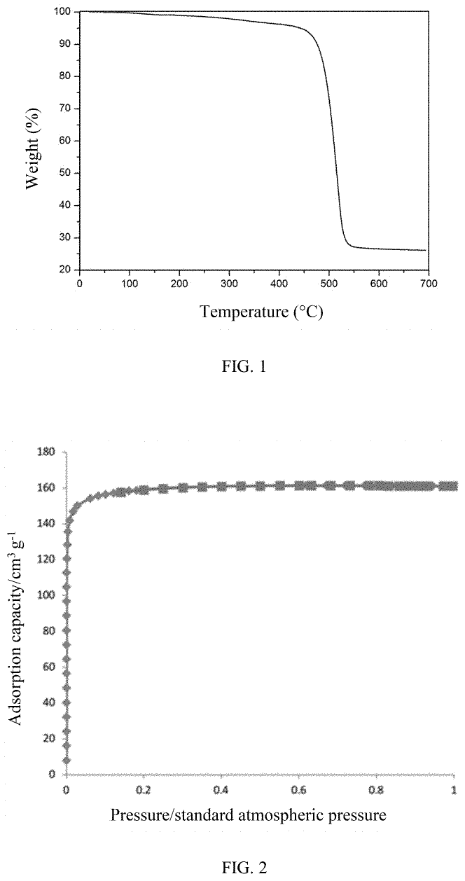

The polyester polyols prepared in Examples 1 to 13 each were subjected to TGA, with Examples 1 and 2 as typical representatives. FIG. 1 corresponds to a TGA curve of the polyester polyol prepared in Example 1, and it can be seen from the figure that an initial decomposition temperature of the polyester polyol prepared in Example 1 is 500° C.

FIG. 4 corresponds to a TGA curve of the polyester polyol prepared in Example 2, and it can be seen from the figure that an initial decomposition temperature of the polyester polyol prepared in Example 2 is 500° C.

Test results of the polyester polyols in other examples are similar to those described above, and initial decomposition temperatures of the polyester polyols are higher than 300° C.

### Example 6 Physical Adsorption Analysis

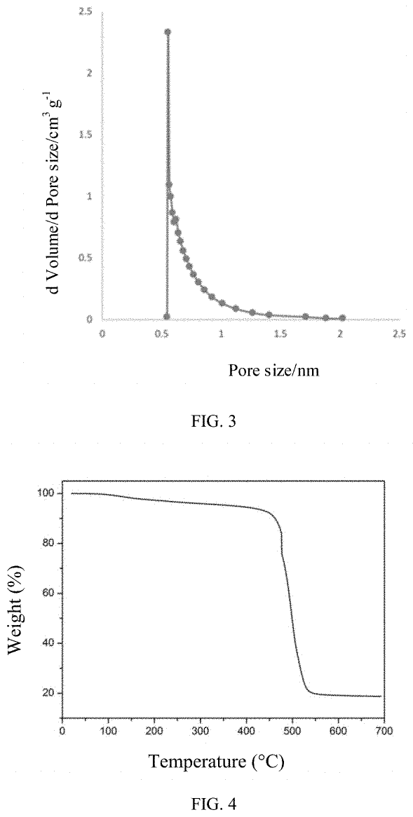

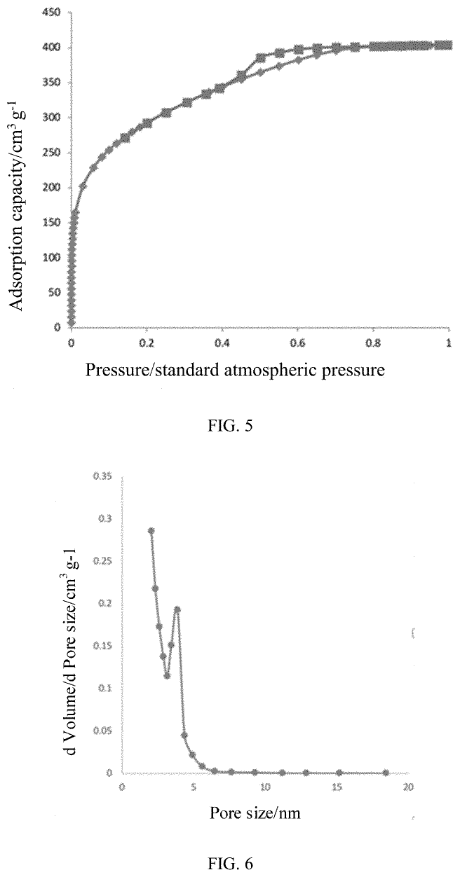

The porous oxides prepared in Examples 1 to 13 each were subjected to physical adsorption characterization, with Examples 1 and 2 as typical representatives. BET curves of Examples 1 and 2 are shown in FIG. 2 and FIG. 5, respectively; and pore distribution curves of Examples 1 and 2 are shown in FIG. 3 and FIG. 6, respectively. FIG. 2 corresponds to a physical adsorption curve of the porous oxide prepared in Example 1, and it can be seen from the figure that the porous oxide prepared in Example 1 is a typical micropore type I adsorption isotherm. FIG. 3 corresponds to a pore distribution curve of the porous oxide prepared in Example 1, and it can be seen from FIG. 3 that pores are distributed at 0.55 nm and a significant peak of the pore distribution curve is at 0.55 nm, indicating that micropores are concentrated at 0.55 nm.

FIG. 5 corresponds to a physical adsorption curve of the porous oxide prepared in Example 2, and it can be seen from the figure that the porous oxide prepared in Example 2 is a typical mesopore type IV adsorption isotherm. FIG. 6 corresponds to a pore distribution curve of the porous oxide prepared in Example 2, and it can be seen from the figure that pores are distributed at 4.0 nm and a significant peak of the pore distribution curve is at 4.0 nm, indicating that mesopores are concentrated at 4.0 nm.

TABLE 3
SSA and pore size information for Examples 1 to 13

| | Nitrogen physical adsorption information | | | |
|---|---|---|---|---|
| Example | BET SSA | Micropore area | External SSA | Pore size |
| No. | m²/g | m²/g | m²/g | nm |
| 1 | 425 | 336 | 89 | 0.55 |
| 2 | 708 | 197 | 511 | 4.0 |
| 3 | 859 | 636 | 223 | 0.42 |
| 7 | 908 | 180 | 728 | 18 |
| 8 | 1202 | 814 | 388 | 1.8 |
| 9 | 1008 | 280 | 728 | 25 |
| 10 | 1378 | 509 | 869 | 4.5 |
| 11 | 1480 | 483 | 997 | 32 |
| 12 | 678 | 58 | 620 | 60 |
| 13 | 226 | 72 | 154 | 72 |

### Example 7 TEM Analysis

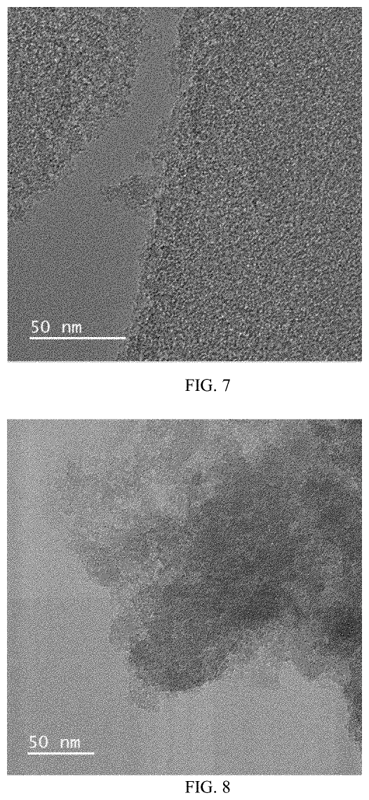

The porous oxides prepared in Examples 1 to 13 each were subjected to TEM characterization, with Examples 1 and 2 as typical representatives. TEM images of Examples 1 and 2 are shown in FIG. 7 and FIG. 8, respectively. FIG. 7 corresponds to a TEM image of the porous oxide prepared in Example 1, and it can be seen from the figure that the porous oxide prepared in Example 1 has a relatively uniform pore size of about 0.5 nm to 0.6 nm, which is concentrated in a micropore range. FIG. 8 corresponds to a TEM image of the porous oxide prepared in Example 2, and it can be seen from FIG. 8 that the porous oxide has a pore size of 4 nm to 5 nm, which is mainly concentrated in a mesopore range.

The above examples are merely few examples of the present application, and do not limit the present application in any form. Although the present application is disclosed as above with preferred examples, the present application is not limited thereto. Some changes or modifications made by any technical personnel familiar with the profession using the technical content disclosed above without departing from the scope of the technical solutions of the present application are equivalent to equivalent implementation cases and fall within the scope of the technical solutions.

What is claimed is:

1. A preparation method of a porous oxide, comprising: preparing the porous oxide with a polyester polyol as a raw material.

2. The preparation method according to claim 1, comprising: in an atmosphere comprising a gas A, roasting the raw material comprising the polyester polyol to obtain the porous oxide,
wherein the gas A is at least one selected from the group consisting of an air, a nitrogen, an inert gas, and an oxygen.

3. The preparation method according to claim 2, wherein the roasting is conducted at 350° C. to 900° C. for 1.5 h to 25 h.

4. The preparation method according to claim 1, comprising: subjecting a raw material comprising an oxygen-containing acid ester and a polyol to a transesterification reaction to obtain the polyester polyol.

5. The preparation method according to claim 4, wherein the oxygen-containing acid ester is at least one selected from the group consisting of a compound with a chemical formula shown in formula I and a compound with a chemical formula shown in formula II:
M(OR¹)ₙ¹ formula I
O═P(OR²)ₙ² formula II
wherein M is a metallic element or a non-metallic element excluding P; R¹ and R² each are independently at least one selected from the group consisting of C₁-C₈ alkyl groups; and n¹ is 2 to 8 and n² is 2 to 8.

6. The preparation method according to claim 5, wherein M is at least one selected from the group consisting of B, Si, Ge, Al, Ti, Fe, Sn, V, Ga, Zr, Cr, Sb, and W.

7. The preparation method according to claim 4, wherein there are no less than two hydroxyl groups in the polyol.

8. The preparation method according to claim 4, wherein the polyol comprises at least one selected from the group consisting of ethylene glycol (EG), diethylene glycol (DEG), triethylene glycol (TEG), tetraethylene glycol, 1,2-propanediol, 1,3-propanediol, 1,4-butanediol, 1,6-hexanediol, polyethylene glycol (PEG) 200, PEG 400, PEG 600, PEG 800, 1,4-cyclohexanediol, 1,4-cyclohexanedimethanol (1,4-CHDM), 1,4-benzenedimethanol, glycerol, trimethylolpropane, pentaerythritol, xylitol, and sorbitol.

9. The preparation method according to claim 4, wherein the transesterification reaction is conducted for 2 h to 10 h at 80° C. to 180° C. under a stirring in an inert atmosphere.

10. A porous oxide, wherein the porous oxide is prepared by the preparation method according to claim 1.

11. The porous oxide according to claim 10, wherein the porous oxide has a pore size of 0.4 nm to 80 nm and a specific surface area (SSA) of 150 m²/g to 1,500 m²/g.

12. The porous oxide according to claim 10, wherein the porous oxide comprises a micropore with a pore size of 0.4 nm to 2.0 nm.

13. The porous oxide according to claim 10, wherein the porous oxide comprises a mesopore with a pore size of 2.0 nm to 50 nm.

14. The porous oxide according to claim 10, wherein the porous oxide comprises a macropore with a pore size of 50 nm to 80 nm.

15. The porous oxide according to claim 10, wherein the preparation method of the porous oxide comprises: in an atmosphere comprising a gas A, roasting the raw material comprising the polyester polyol to obtain the porous oxide,
wherein the gas A is at least one selected from the group consisting of an air, a nitrogen, an inert gas, and an oxygen.

16. The porous oxide according to claim 15, wherein the roasting in the preparation method of the porous oxide is conducted at 350° C. to 900° C. for 1.5 h to 25 h.

17. The porous oxide according to claim 10, wherein the preparation method of the porous oxide comprises: subjecting a raw material comprising an oxygen-containing acid ester and a polyol to a transesterification reaction to obtain the polyester polyol.

18. The porous oxide according to claim 17, wherein the oxygen-containing acid ester is at least one selected from the group consisting of a compound with a chemical formula shown in formula I and a compound with a chemical formula shown in formula II:
M(OR¹)ₙ¹ formula I
O═P(OR²)ₙ² formula II
wherein M is a metallic element or a non-metallic element excluding P; R¹ and R² each are independently at least one selected from the group consisting of C₁-C₈ alkyl groups; and n¹ is 2 to 8 and n² is 2 to 8.

19. The preparation method according to claim 18, wherein M is at least one selected from the group consisting of B, Si, Ge, Al, Ti, Fe, Sn, V, Ga, Zr, Cr, Sb, and W.

20. The preparation method according to claim 17, wherein there are no less than two hydroxyl groups in the polyol.
